(19) United States
(12) Patent Application Publication
(10) Pub. No.: US 2024/0423305 A1
(43) Pub. Date: Dec. 26, 2024

(54) FACE MASK

(71) Applicants: The University of Melbourne, Melbourne (AU); Western Health, Footscray (AU)

(72) Inventors: David John COLLINS, Victoria (AU); Forbes MCGAIN, Footscray (AU); Matthew John GUEST, Footscray (AU); Kirill KOLESNIK, Victoria (AU); Dale Maxwell Fletcher CHAPMAN, Victoria (AU)

(73) Assignees: The University of Melbourne, Melbourne (AU); Western Health, Footscray (AU)

(21) Appl. No.: 18/683,413

(22) PCT Filed: Aug. 12, 2022
(86) PCT No.: PCT/AU2022/050889

§ 371 Date: Feb. 13, 2024

(30) Foreign Application Priority Data
Aug. 13, 2021 (AU) 2021902533

(51) Int. Cl. A41D 13/11; A62B 18/08; A62B 23/02

(52) U.S. Cl. CPC A41D 13/1138; A62B 18/08; A62B 23/025

(57) ABSTRACT

According to an aspect of the present invention, there is provided a face mask, comprising: a frame defining a respiratory chamber, for receiving nose and mouth portions of a user, between a proximal end of the frame for interfacing with a face portion of the user and a distal end of the frame configured for allowing gas exchange with the environment; a vocal guide defined by a sectional portion of the frame, the guide comprising an arched nose ridge portion, side wall portions extending from the nose ridge portion and a base connecting the side wall portions, wherein the guide is configured with an inwardly-projecting contour located at one or more regions of each of the side wall portions so as to alter an output frequency response of sound waves travelling through the frame for improving speech intelligibility of the mask during use.

### CROSS-REFERENCE TO RELATED APPLICATIONS

The present application is a national phase entry under 35 U.S.C. § 371 of International Application No. PCT/AU2022/050889, filed Aug. 12, 2022, published in English, which claims priority from Australian Patent Application Serial No. 2021902533, filed Aug. 13, 2021, both of which are incorporated herein by reference.

### FIELD OF THE INVENTION

This invention relates to a protective face mask, and in particular a reusable respirator face mask with enhanced speech intelligibility properties.

### BACKGROUND

Usage of face masks has become increasingly common in parts of the society for reasons including protection against the spread of infectious diseases. Protective masks typically range from simple one-piece cloth masks to more advanced respirator masks with replaceable air filters. While variations of protective masks are available based on functional, comfort and aesthetic qualities, one underlying problem that persists with mask designs revolves around conventional masks' inherent limitations with respect to sound propagation.

Layers of materials used in a conventional mask directly interfere with acoustic energy, and therefore speech transmissions, through the mask, particularly for mask designs that provide a tight seal between the mask and the user's face. This often results in a reduction in the clarity and volume of sound output, which could adversely impact on a person's speech intelligibility when using such masks. This sound impairment effect may be exacerbated by environments with a noisy background, such as in hospitals where typical background noise level could reach in excess of 75 dB. Additionally, silicon and elastomeric materials that are chosen for use in masks for comfort may have sound absorption properties which may further reduce speech intelligibility.

Some mask designs aim to reduce or mitigate problems associated with poor sound transmissions by incorporating an active microphone and speaker system within the mask, or integrating thin diaphragms or membranes into the mask. However, these approaches are not ideal as they add to the cost of manufacturing. In addition, such embedded systems and movable components are susceptible to damage, contamination, airflow leakages and component failure. Expensive and complex masks using the aforementioned systems limit the reliability, applicability and adoption of these masks while contributing to greater levels of economic waste from failed/damaged devices.

Therefore, there exists a need for a solution that provides users with adequate protection while improving speech intelligibility over conventional masks. The solution should ideally be applicable for reusable masks that are easy to maintain and clean, and not be expensive to manufacture.

The applicant has determined that it would be advantageous to provide a face mask which, in its preferred embodiments, seeks to at least in part alleviate the above-identified problems or to offer the public with a useful choice.

### SUMMARY OF THE INVENTION

According to an aspect of the present invention, there is provided a face mask, comprising: a frame defining a respiratory chamber, for receiving nose and mouth portions of a user, between a proximal end of the frame for interfacing with a face portion of the user and a distal end of the frame configured for allowing gas exchange with the environment; a vocal guide defined by a sectional portion of the frame, the guide comprising an arched nose ridge portion, side wall portions extending from the nose ridge portion and a base connecting the side wall portions, wherein the guide is configured with an inwardly-projecting contour located at one or more regions of each of the side wall portions so as to alter an output frequency response of sound waves travelling through the frame for improving speech intelligibility of the mask during use.

Preferably, the guide is configured with an outwardly-projecting contour located at a region of the nose ridge portion.

Preferably, the outwardly-projecting contour is located at a region of the nose ridge portion towards the distal end of the frame.

Preferably, the outwardly-projecting contour deviates from a frame surface by a range of between about 1 mm and about 2 mm.

Preferably, the inwardly-projecting contour region covers a substantial surface area of the respective side wall portions.

Preferably, the inwardly-projecting contour deviates from a frame surface by a range of between about 1 mm and about 5 mm, and more preferably about 3.5 mm.

Preferably, the magnitude of a deviation of the contour from a frame surface increases progressively towards a centre region of the contour.

Preferably, the guide is configured to increase the sound pressure level output of sound waves at any one or more of the following frequency values: 1 KHz, 2 KHz, 4 KHz, 5 KHz and 8 KHz.

Preferably, the guide is configured to increase the sound pressure level output of the mask by about 1 dB to about 6 dB higher than a mask without any inwardly-projecting contours located at one or more regions of each of the side wall portions.

Preferably, the frame further comprises a face-contacting seal secured to the proximal end of the frame.

Preferably, the frame further comprises a filtration unit secured to the distal end of the frame, the filtration unit comprises a replaceable air filter and a filter enclosure.

Preferably, the filter enclosure comprises two rigid shells, and the air filter is located therebetween.

Preferably, the frame further comprises clips for receiving one or more mask straps.

Preferably, the frame comprises an assembly of components.

Alternatively, the frame comprises a one-piece construction.

Preferably, the mask is a reusable respirator mask.

Preferably, the vocal guide is constructed from a material having an acoustic absorption coefficient of below about 0.2 across any one or more of the following frequencies: about 160 Hz, about 200 Hz, about 250 Hz, about 315 Hz, about 400 Hz, about 500 Hz, about 630Hz, about 1,000 Hz, about 1,250 Hz, about 1,600 Hz, about 2,000 Hz, about 2,500 Hz, about 3,150 Hz, about 4,000 Hz, about 5,000 Hz, about 6,300 Hz, and about 8,000 Hz.

According to another aspect of the present invention, there is provided a face mask kit comprising a frame and a vocal guide as described above, and further comprising a face-contacting seal securable to a proximal end of the frame and a filtration unit securable to a distal end of the frame.

According to a further aspect of the present invention, there is provided a vocal guide for use with a face mask comprising a frame defining a respiratory chamber, for receiving nose and mouth portions of a user, between a proximal end of the frame for interfacing with a face portion of the user and a distal end of the frame configured for allowing gas exchange with the environment, the vocal guide being defined by a sectional portion of the frame, the guide comprising an arched nose ridge portion, side wall portions extending from the nose ridge portion and a base connecting the side wall portions, and wherein the guide is configured with an inwardly-projecting contour located at one or more regions of each of the side wall portions so as to alter an output frequency response of sound waves travelling through the frame for improving speech intelligibility of the mask during use.

Further aspects of the present invention and further embodiments of the aspects described in the preceding paragraphs will become apparent from the following description.

While components of the face mask will be described below for use in combination with each other in the preferred embodiments of the present invention, it is to be understood by a skilled person that some aspects of the present invention are equally suitable to be used interchangeably between one or more embodiments of the present invention and/or suitable for use as standalone inventions that can be individually incorporated into other face masks and assemblies not described herein.

The word “about” or “approximately” when used in relation to a stated reference point for a quality, level, value, number, frequency, percentage, dimension, location, size, amount, weight or length may be understood to indicate that the reference point is capable of variation, and that the term may encompass proximal qualities on either side of the reference point. In some embodiments, the word “about” may indicate that a reference point may vary by as much as 30, 25, 20, 15, 10, 9, 8, 7, 6, 5, 4, 3, 2, or 1 percent.

As used herein, the word “substantially” may be used merely to indicate an intention that the term it qualifies should not be read too literally and that the word could mean “sufficiently”, “mostly” or “near enough” for the patentee's purposes.

### DESCRIPTION OF THE DRAWINGS

The invention will now be described, by way of non-limiting example only, with reference to the accompanying drawings, in which:

FIG. 1 is a perspective front view of a face mask according to an exemplary embodiment of the invention;

FIG. 2 is a perspective rear view of the face mask of FIG. 1;

FIG. 3 is an exploded view showing the relationship between the sub-components of a frame of the face mask of FIG. 1;

FIGS. 4A to 4F show a set of sectional views of a vocal guide portion of the face mask of FIG. 1;

FIGS. 5A to 5D show vocal guide portions of the face mask with indications of contour changes on regions of the guide portions in the form of heat maps;

FIGS. 6A and 6B show a comparison of two vocal guide portions;

FIG. 7 shows charts which indicate the relative sound level performance of a face mask according to an embodiment of the invention;

FIG. 8 is a chart showing experimental and simulated performance of a face mask according to an embodiment of the invention at key frequency values;

FIG. 9 is a perspective front view of a face mask according to another embodiment of the invention;

FIG. 10 is a perspective rear view of the face mask of FIG. 9;

FIG. 11 is a side exploded view showing the relationship between the sub-components of a frame of the face mask of FIG. 9;

FIG. 12 is a rear perspective exploded view of the face mask of FIG. 9;

FIG. 13 is a front perspective view of the vocal guide portion of the face mask of FIG. 9;

FIG. 14 is a rear perspective view of the vocal guide portion of the face mask of FIG. 9; and

FIG. 15 shows an assembled face mask according to an embodiment of the invention as mounted in a typical usage position on a user's face.

### DETAILED DESCRIPTION

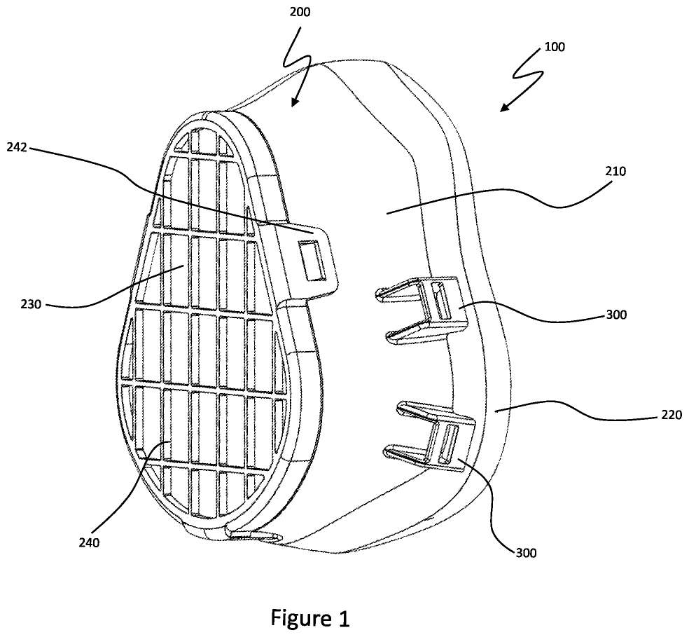

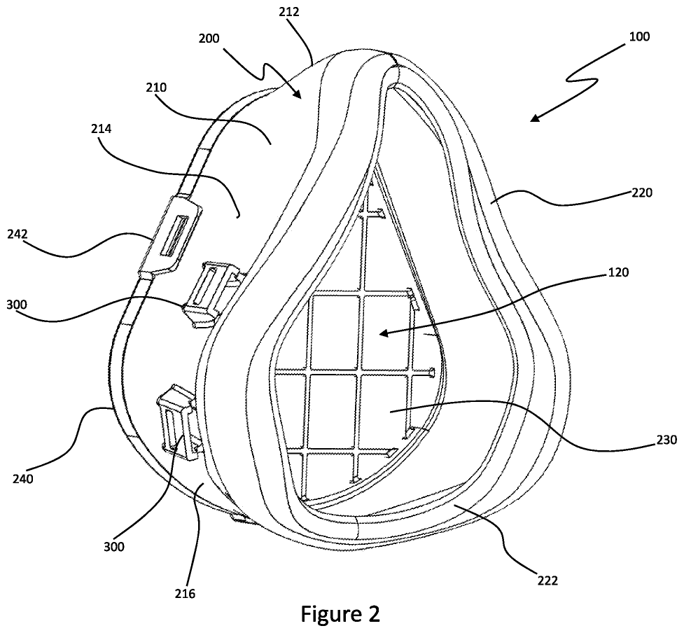

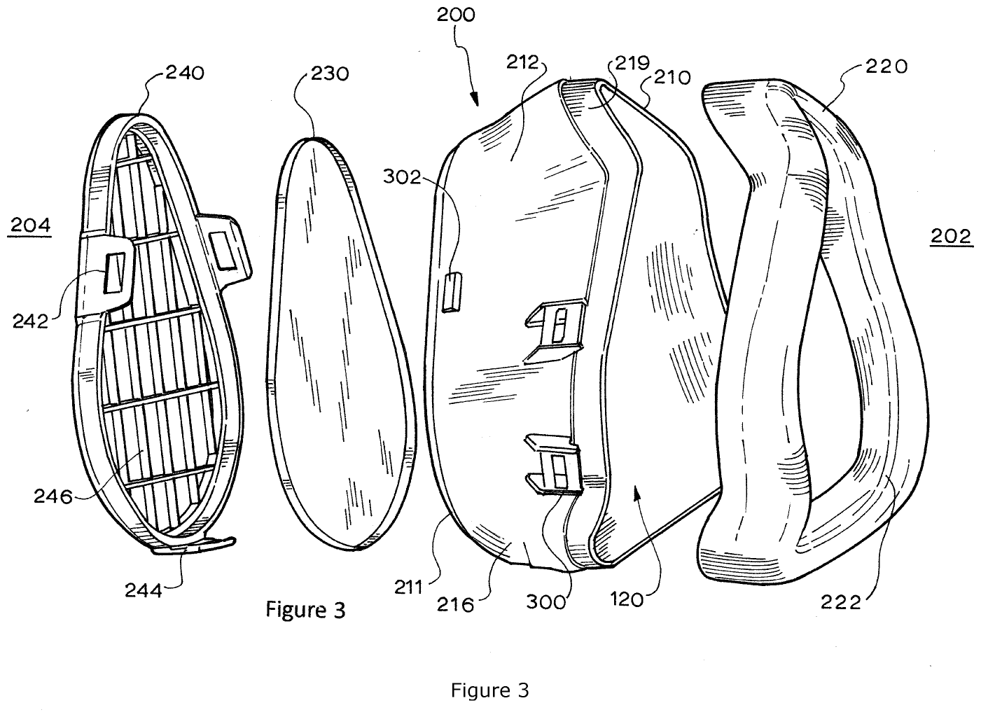

FIGS. 1 to 3 show an exemplary embodiment of the present invention, in which a face mask 100, of the reusable respiratory kind, comprises a frame 200 for interfacing with a user's face 102 during use, and the frame 200 defines a respiratory chamber 120 which is configured for accommodating the user's mouth and at least a portion of the user's nose. While reusable respiratory face mask designs have been shown here to be used for preferred embodiments of the invention, it is to be understood that the invention is not limited to the type of mask designs shown or described with respect to the embodiments, and that the invention may be suitable for use with other mask designs not described herein.

In the preferred embodiment, the frame 200, which defines the respiratory chamber 120, is assembled from a number of sub-components, including a face-contacting seal 220 for interfacing with a user's face, a vocal guide 210 portion, a replaceable filter 230 and a filter enclosure 240. The sub-components are designed to be securable to one another in a serial manner, preferably by means of interference or frictional fit, so as to provide a unified/assembled frame body 200. The frame body 200 is provided with fastening means such as clips 300 on one or more of the sub-components for receiving, or attaching to, one or more mask straps (not shown) for mounting the face mask 100 on a user's face. In some alternative configurations, the entirety of the frame body 200 may be of a one-piece construction. In other configurations, the mask frame 200 comprises only the respiratory chamber 120 and the face-contacting seal 220.

The frame 200 has a proximal end 202 which is the end closer to the user during use and a distal end 204 designed for allowing air flow between the respiratory chamber 120 and the ambient environment. In embodiments where the frame 200 is assembled with sub-components, the face-contacting seal 220 is secured to the proximal end 202 of the frame 200 via friction connection 219, and a filtration unit, comprising the replaceable filter 230 and the filter enclosure 240, is secured via connection point 211 to the distal end 204 of the frame 200. The face-contacting seal 220 typically provides comfortable/soft contact portions 222 or cushions made from silicon or elastomeric material for interfacing with, and securely sealing against, the face 102 of the user to minimise gas flow leakage from the respiratory chamber 120.

The filtration unit provides the function of filtering airflow between the respiratory chamber 120 and the ambient environment, and replaceable filters 230 is used in the preferred embodiments of the invention to allow reusability of the face mask 100 and to improve longevity of the mask 100. In one embodiment, the replaceable filter 230 is secured at the distal end 204 of the frame 200, for example by connection points 242, 244, against a projection 302 of the frame 200, and the filter enclosure 240 is mounted over the replaceable filer 230 to secure it in position so that the only airflow in and out of the respiratory chamber 120, when in use, is directed through the replaceable filter 230. The filter enclosure 240 can be provided with grilles 246 or ribs for maintaining pathways for airflow and for retaining the replaceable filter 230 in place. Different types of filtration units and replaceable filters 230 known to a skilled addressee may be suitably used with the face mask 100 as described without departing from the spirit of the invention. In one embodiment, the filter enclosure 240 for housing the replaceable filter 230 is in the form of two rigid shells which receives or locates the replaceable filter 230 in between the shells. The terms air flow and gas exchange as used in this specification refer to breathable air or concentration of gases suitable for breathing by a user when donning the face mask.

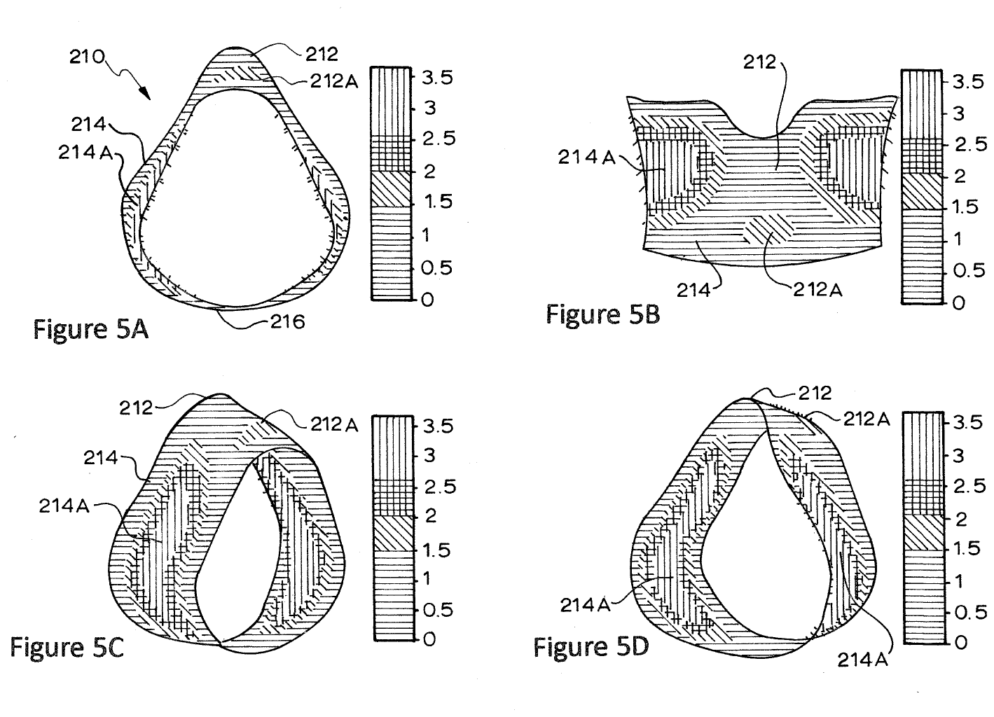

The face mask 100 comprises a vocal guide 210 portion which is defined as part of the frame 200 in the preferred embodiment. In particular, the vocal guide 210 portion is defined to be a sectional portion of the frame, and more particularly the portion of the frame 200 which has substantial influence on the movement of sound waves inside the respiratory chamber 120. It is to be understood that the vocal guide 210 portion can be a partial section of the frame 200. In the preferred embodiment and with reference to FIGS. 5A to 5D, the vocal guide 210 portion comprises an arched nose ridge portion 212, side wall portions 214 extending downwardly from the nose ridge portion 212 and a base 216 connecting the side wall portions 214.

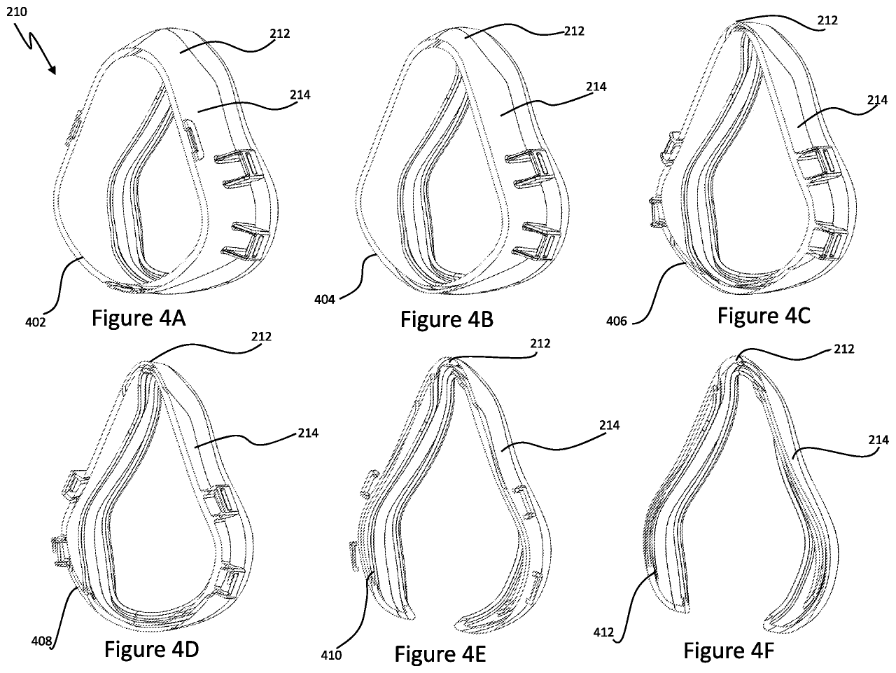

The inventors have discovered that geometrical configurations of the vocal guide 210 portion can be modified to improve the frequency response performance of sound waves travelling from the respiratory chamber 120 through the filtration unit of the face mask 100. By altering certain geometries of the vocal guide 210 portion as discussed below, select frequencies that are important to speech intelligibility (frequencies that are known to carry vocal sound, for example the frequency range of about 1,000 Hz to about 3,000 Hz) can be substantially retained or enhanced and therefore face masks incorporating the vocal guide 210 have been observed to achieve higher speech intelligibility scores over masks with unaltered vocal guide 210 portions (i.e. no localised geometric deviation of the internal surface contours of the vocal guide 210 from a plain frame surface). One approach for measuring speech intelligibility is the Speech Intelligibility Index (SII), while another known metric is the Articulation Index (AI). In particular, and with reference to FIGS. 4 to 6, it has been observed that output frequency response of sound waves travelling through the frame 200 can be altered for improving speech intelligibility (as measured, for example, by a SII value) of a face mask by adding one or more contoured portions 212A, 214A, which are localised geometric deviation of the internal surface contours of the wall of the vocal guide 210. Non-limiting examples of contoured portions 212A, 214A could include: (1) adding a localised outwardly-projecting contour at a region of the nose ridge portion of the vocal guide 210 portion, and/or (2) adding localised inwardly-projecting contours at one or more regions of each of the side wall portions of the vocal guide 210 portion. It is to be appreciated that the contoured portions 212A, 214A may be generally outwardly-projecting from the vocal guide 210 or inwardly-projecting into the vocal guide 210, or a combination of both. Alternatively, the contoured portions 212A, 214A may be configured to only alter the inner geometries of the vocal guide 210 so as not to show any visible contours or alterations on the outside surface of the vocal guide 210.

The select range of frequencies to substantially retain and/or enhance through the vocal guide 210 include the following non-limiting frequencies or frequency ranges: about 160 Hz, about 200 Hz, about 250 Hz, about 315 Hz, about 400 Hz, about 500 Hz, about 630Hz, about 1,000 Hz, about 1,250 Hz, about 1,600 Hz, about 2,000 Hz, about 2,500 Hz, about 3,150 Hz, about 4,000 Hz, about 5,000 Hz, about 6,300 Hz, and about 8,000 Hz. In the context of the preferred embodiments, retaining the select frequencies/frequency ranges means allowing greater acoustic energy in said select frequencies to travel through the vocal guide 210 and mask frame 200—for example, allowing acoustic energy to pass through the mask frame 200, without losing acoustic energy. Enhancing the select frequencies/frequency ranges means amplifying acoustic energy in said select frequencies to travel through the vocal guide 210 and mask frame 200.

FIGS. 5A to 5D show locations and degrees of geometric alteration in accordance with a preferred embodiment of the invention, and in particular contoured sections of the vocal guide 210 portion with varying degrees of outward-and inward-projections such that localised surface geometries of the altered regions are raised or depressed compared with an altered plain frame surface. FIGS. 4A to 4F show sectional views across a longitudinal length of the vocal guide 210 portion of the frame 200 so as to show the changes in surface contour of the vocal guide 210 portion. It is to be appreciated that the localised inwardly or outwardly-projecting contours may be formed or located on an internal wall of the vocal guide 210, and such contours may in some embodiments not be visible or observable on the external wall of the vocal guide 210. The localised inwardly or outwardly-projecting contours as used herein refer to alterations to the surface geometries (surface raises and dips) of the vocal guide 210 portion of the mask that are incorporated into the mask in addition to standard geometries of the mask for accommodating conventional facial features of a user (such as a standard ridge in the mask shape for accommodating a nose).

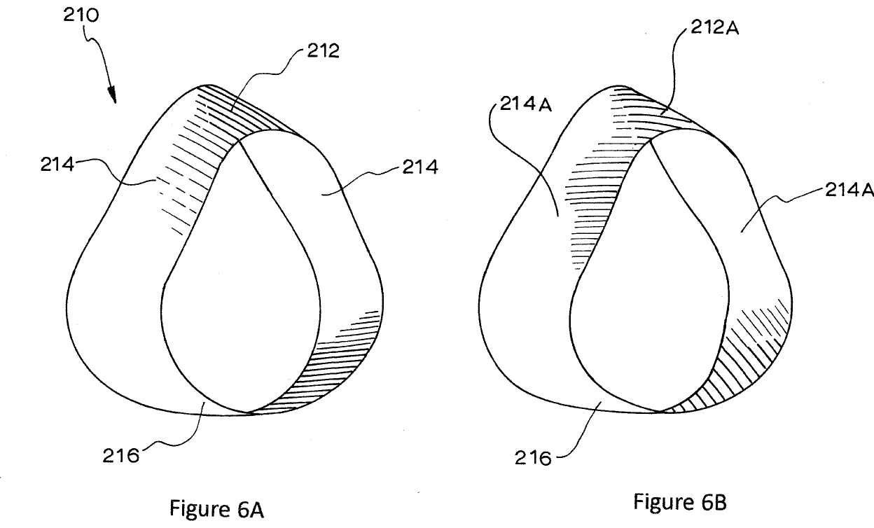

FIG. 6A shows a vocal guide 210 portion with unaltered geometries having no localised deviations in surface contours from a plain shape of the frame 200, and FIG. 6B shows a vocal guide 210 portion with altered geometries for improved frequency response. Specifically, the embodiment as shown in FIG. 6B has an outwardly-projecting contour portion 212A located at a crown region of the arched nose ridge portion 212, in which the contour of altered area is raised outwardly from the region. More specifically, the outwardly-projecting contour deviates (raises higher) from the plain/normal frame surface by a range of between about 1 mm and about 2 mm. Also, in accordance with the preferred embodiment, the outwardly-projecting contour portion 212A is located at an end of the crown region of the arched nose ridge 212 that is towards the distal end of the frame 200. Further, the embodiment shown in FIGS. 5C, 5D and 6B show inwardly-projecting contour portions 214A located at side wall portions 214 of the vocal guide 210 portion such that the contour of the altered area is substantially depressed inwardly towards the respiratory chamber 120. In particular, the inwardly-projecting contour portions 214A deviates (pushes surface contour lower) from the plain/normal frame surface by a range of between 1 mm and 3.5 mm. In some embodiments, this deviation may be up to about 5 mm. In the preferred embodiment, the inwardly-projecting contour region covers a substantial surface area of the respective side wall portions 214 as seen in FIG. 5C, for example.

The altered surface contour areas 212A, 214A of the vocal guide 210 portion of the frame 200 may have varying degrees of deviation from a plain/normal frame surface, and in the preferred embodiment, the degree/magnitude of deviation increases progressively towards a centre region of the altered contour area. It is to be understood that the above measurements have been provided as non-limiting examples for certain embodiments of the invention, and that the degree of deviation of the altered surface contour areas 212A, 214A of the vocal guide 210 portion may change depending on the configuration of mask frames 200 via experimentation without departing from the spirit of the invention.

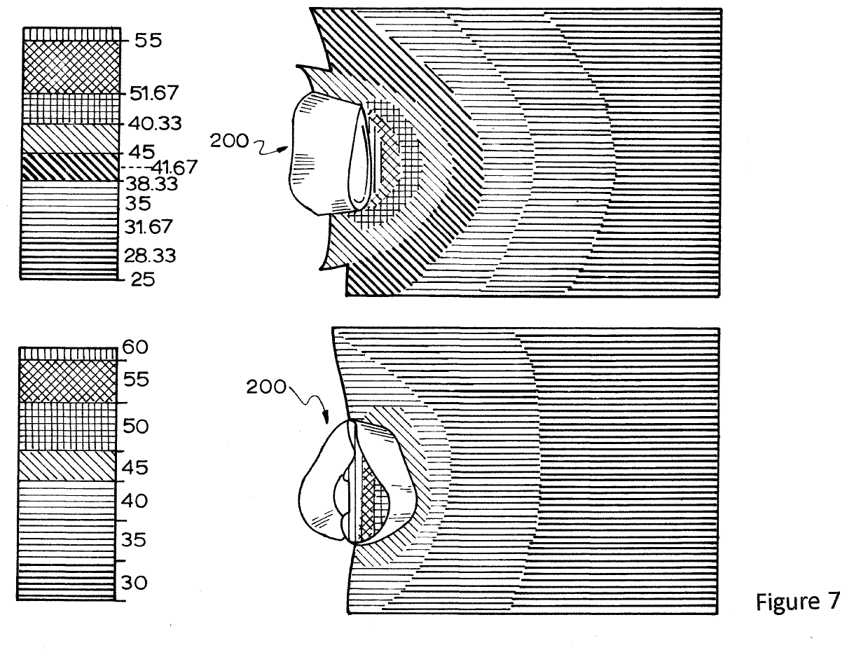

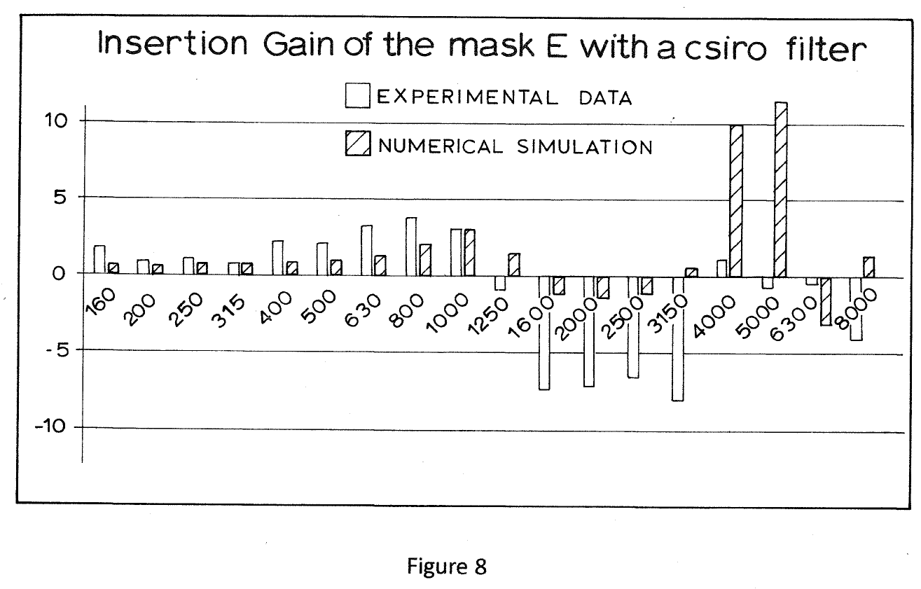

It has been observed that altering the geometric surface contour areas 212A, 214A of the vocal guide 210 portion of the frame 200 leads to improvements in the frequency response of sound wave outputs for a range of vocal sound frequencies by effectively concentrating and directing the acoustic energy inside the frame 200—all doing so without requiring the use of expensive active speakers or problematic membrane insertions in the mask frame 200. Changing the geometries of the vocal guide 210 portion section of the frame 200 as described has been effective in increasing the sound pressure levels of outputs as seen in FIGS. 7 and 8 across key sound frequencies (associated with speech) which leads to improving the perceived clarity of sound. In some configurations, the a mask 100 having a vocal guide 210 portion as altered above is able to increase the sound pressure level output, compared with unaltered mask frames 200 or conventional disposable n95 face masks, at one of more of the following non-limiting frequency values/ranges: about 160 Hz, about 200 Hz, about 250 Hz, about 315 Hz, about 400 Hz, about 500 Hz, about 630Hz, about 1,000 Hz, about 1,250 Hz, about 1,600 Hz, about 2,000 Hz, about 2,500 Hz, about 3,150 Hz, about 4,000 Hz, about 5,000 Hz, about 6,300 Hz, and about 8,000 Hz. In some embodiments, sound pressure levels output of the mask 100 may be increased by about 1 dB to about 6 dB. It has been further observed that the mask frame 200 with an altered vocal guide 210 portion as described could be configured to output, during use in the intended user environment, an SII value of 0.5 or greater, (compared with a control mask without any vocal guide alterations), which represents meaningful improvements in speech intelligibility when compared with an SII value of 0.45 for a masks 100 with unaltered vocal guide 210 portions. SII values between 0.45 and 0.5 are commonly recommended as a threshold between only being able to transmit simple message and being able to understand complex instructions.

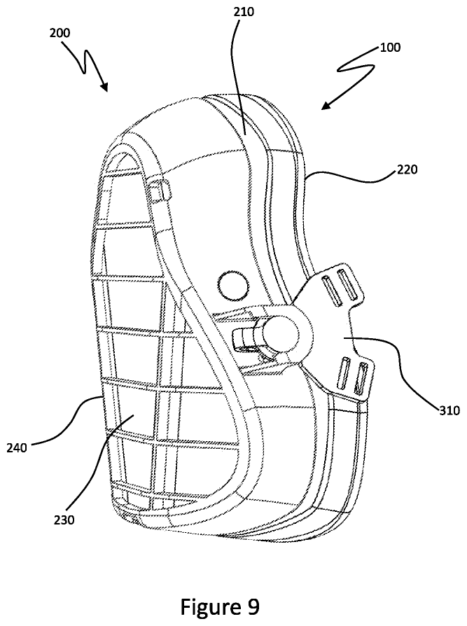

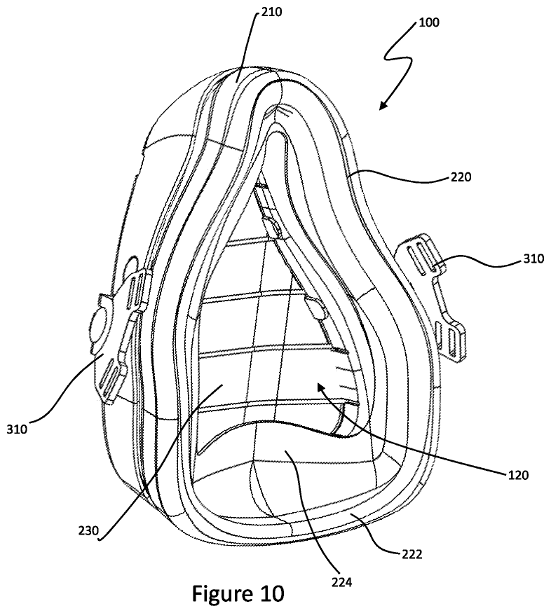

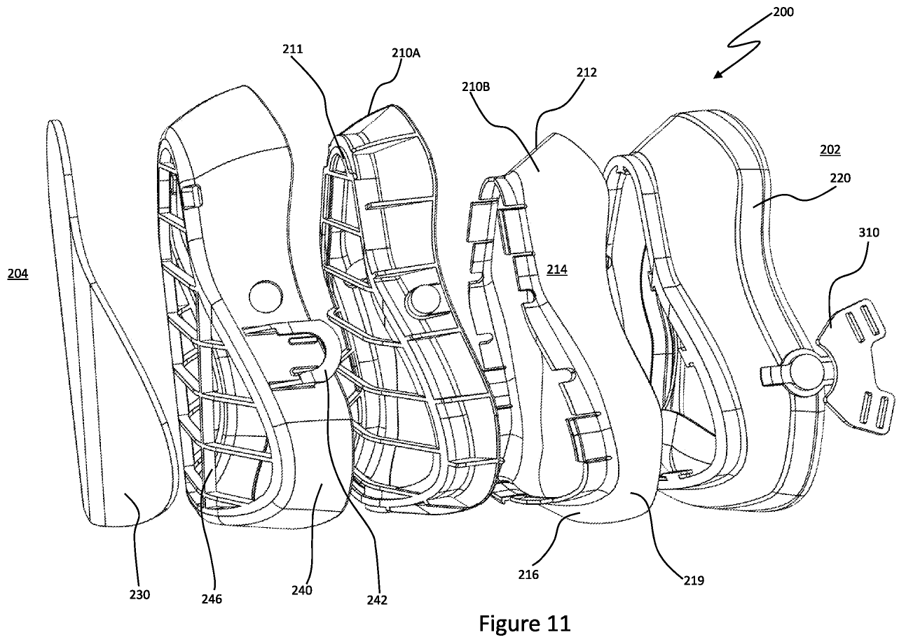

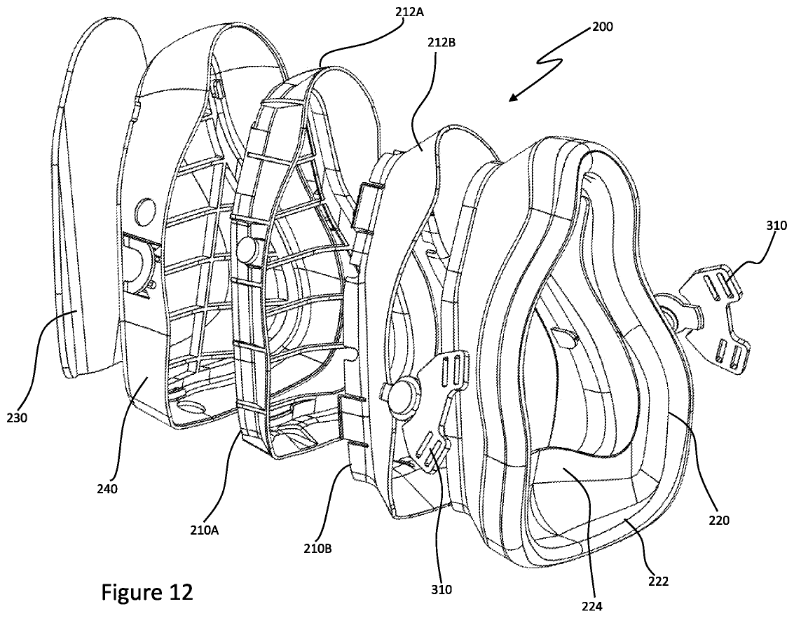

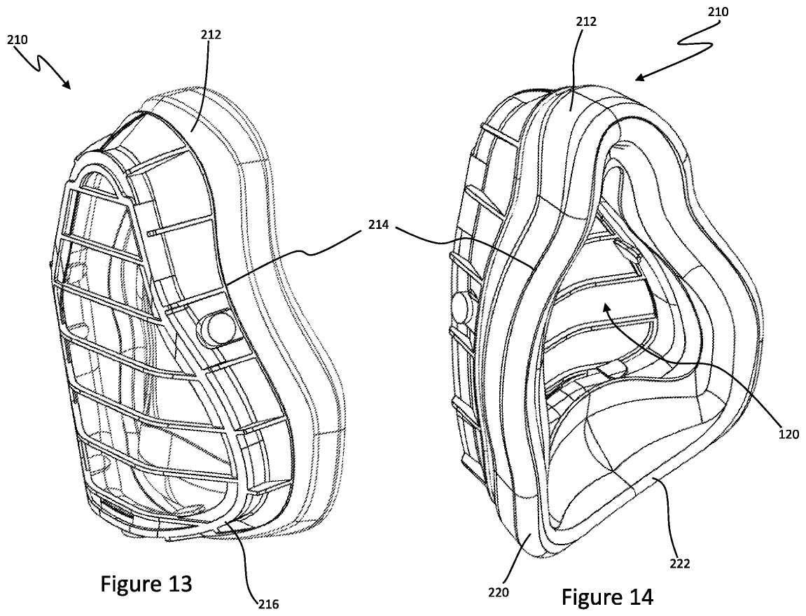

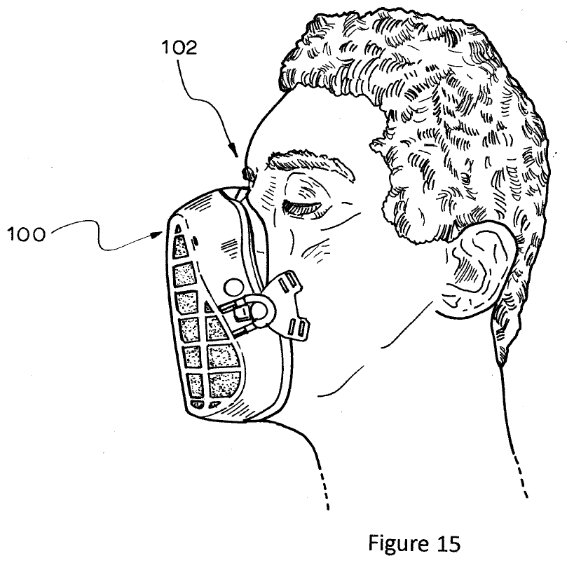

FIGS. 9 to 14 show a further embodiment of the face mask 100 in accordance with the present invention. FIG. 15 shows the assembled face mask 100 of the further embodiment as mounted in a typical usage position on a user's face 102. The face mask 100 comprises a mask frame 200 which defines a respiratory chamber 120 with two vocal guide parts 210A, 210B. The vocal guide parts of the frame 200 is similarly arranged at connection points 211, 219 to couple at a proximal end 202 with a face-contacting seal 220 and to a replaceable filter 230 and filter enclosure 240 at a distal end 204. This embodiment differs from the one described above in a number of ways, including differences in the face-contacting seal 220, in which a chin contact 224 has been introduced to improve the sealing connection between the mask frame 200 and the user's face during use. The face-contacting seal 220 has been provided with swivel clips 310 for receiving a mask strap (not shown) for mounting the face mask 100 to the user.

The frame portion 210A is also a rigid intermediate frame part in this embodiment which provides a secondary role of interfacing with the rigid filter enclosure 240 via press-release bias connections on each side of the frame part 210A. Both the frame part 210A and the filter enclosure 240 are provided with grilles 246 or ribs to allow airflow between the respiratory chamber 120 and the ambient environment while holding the replaceable filter 230 in place. The frame part 210A and filter enclosure 240 can be disconnected to access and replace the filter 230. In the further embodiment, face-contacting seal 220 is securable directly with the rigid filter enclosure 240 using friction fit fastening means 242, which holds the assembled mask frame 200 in place. This arrangement as described advantageously provides a compact frame assembly 200 that is easy to assemble, holds the sub-components securely, and provides convenient access for replacing the filter 230.

The vocal guide parts 210A, 210B of the embodiment as shown in FIGS. 9 to 14 comprise an arched nose ridge portion 212, two side wall portions 214 extending below the nose ridge portion 212 and a base 216 joining the side wall portions 214. The vocal guide parts 210A, 210B can be similarly modified by altering geometrical contour portions of the guide parts as described in the principles above for improving the SII value of the mask.

It is to be appreciated that, for some embodiments, the determination of the location of the outwardly-and inwardly-projecting contours on the vocal guide 210 portion and the corresponding magnitude of deviation values may be derived or determined by experimentation or by using computing algorithms and simulations. One method to determine the vocal guide 210 geometry values is to optimise for certain sound frequencies in view of the topology of the mask frame 100 based on the SII to maximise the transmission of acoustic energy. For example, a numerical routine that performs weighted multi-frequency band optimisation can be used for a range of different geometrical boundary condition constraints to passively concentrate and direct acoustic energy out of the mask frame 200. The geometry values of the vocal guide 210 portion of the frame 200 can, for example, be evaluated according to the SII using a weighted contribution of sound to noise ratio in individual frequency bands. The SII can be computed as the summation of band audibility function in relation to ⅓ octave central frequencies (about 160 Hz, about 200 Hz, about 250 Hz, about 315 Hz, about 400 Hz, about 500 Hz, about 630Hz, about 1,000 Hz, about 1,250 Hz, about 1,600 Hz, about 2,000 Hz, about 2,500 Hz, about 3,150 Hz, about 4,000 Hz, about 5,000 Hz, about 6,300 Hz, and about 8,000 Hz).

While the face mask 100 has been described to have a frame 200 formed by a number of sub-components, the scope of the invention also covers a face mask kit in which all the sub-components as described above are provided for assembly by a user. This include a face mask having the following components: a frame 200 and a vocal guide 210 as described above, and a face-contacting seal 220 securable to a proximal end 202 of the frame 200 and a filtration unit securable to a distal end 204 of the frame 200. In the preferred embodiments, the vocal guide 210 portion of the frame 200 is constructed of rigid material (such as plastic) having suitably low acoustic attenuation properties. In such embodiments, a substantial portion of an inner surface of the vocal guide 210 portion of the frame 200 has a relatively low acoustic absorption coefficient. A non-limiting range of suitable acoustic absorption coefficients across any one or more of the ⅓ octave central frequencies (about 160 Hz, about 200 Hz, about 250 Hz, about 315 Hz, about 400 Hz, about 500 Hz, about 630Hz, about 1,000 Hz, about 1,250 Hz, about 1,600 Hz, about 2,000 Hz, about 2,500 Hz, about 3,150 Hz, about 4,000 Hz, about 5,000 Hz, about 6,300 Hz, and about 8,000 Hz) for the material used for the inner surface of vocal guide 210 include: below about 0.6; below about 0.5; below about 0.4; below about 0.3; below about 0.2; below about 0.1; and below about 0.05. In other words, preferred embodiments of the face mask incorporating the vocal guide 210 as described above have improved ability to retain and/or enhance acoustic energy travelling through the vocal guide 210 at one or more select frequencies above, particularly frequencies that generally carry vocal information.

The face mask 100 according to aspects of the present invention can be constructed with any suitable material for mask construction, including materials not specifically described herein. Suitable materials may also include material used for producing components by 3D printing.

In the description and drawings of this embodiment, same reference numerals are used as have been used in respect of the first embodiment, to denote and refer to corresponding features.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A face mask, comprising:
a frame defining a respiratory chamber, for receiving nose and mouth portions of a user, between a proximal end of the frame for interfacing with a face portion of the user and a distal end of the frame configured for allowing gas exchange with the environment;
a vocal guide defined by a sectional portion of the frame, the guide comprising an arched nose ridge portion, side wall portions extending from the nose ridge portion and a base connecting the side wall portions,
wherein the guide is configured with a contoured portion located at one or more regions of each of the side wall portions so as to substantially retain acoustic energy in select frequencies of sound waves travelling through the frame for improving speech intelligibility of the mask during use.

2. A face mask according to claim 1, wherein the contoured portion is an inwardly-projecting contour.

3. A face mask according to claim 1, wherein the contoured portion is an outwardly-projecting contour.

4. A face mask according to claim 1, wherein the contoured portion is located at a region of the nose ridge portion.

5. A face mask according to claim 4, wherein the contoured portion is located at a region of the nose ridge portion towards the distal end of the frame.

6. A face mask according to claim 1, wherein the contoured portion deviates from a frame surface by a range of between about 1 mm and about 2 mm.

7. A face mask according to claim 1, wherein the contoured portion covers a substantial surface area of the respective side wall portions.

8. A face mask according to claim 1, wherein the contoured portion deviates from a frame surface by a range of between about 1 mm and about 5 mm, and more preferably about 3.5 mm.

9. A face mask according to claim 1, wherein the magnitude of a deviation of a contour of the contoured portion from a frame surface increases progressively towards a centre region of the contour.

10. A face mask according to claim 1, wherein the guide is configured to increase the sound pressure level output of sound waves at any one or more of the following frequency values: about 160 Hz, about 200 Hz, about 250 Hz, about 315 Hz, about 400 Hz, about 500 Hz, about 630 Hz, about 1,000 Hz, about 1,250 Hz, about 1,600 Hz, about 2,000 Hz, about 2,500 Hz, about 3,150 Hz, about 4,000 Hz, about 5,000 Hz, about 6,300 Hz, and about 8,000 Hz.

11. A face mask according to claim 1, wherein the guide is configured to increase the sound pressure level output of the mask by about 1 dB to about 6 dB higher than a mask without any contour portions located at one or more regions of each of the side wall portions.

12-15. (canceled)

16. A face mask according to claim 1, wherein the frame comprises an assembly of components.

17. (canceled)

18. A face mask according to claim 1, wherein the mask is a reusable respirator mask.

19. A face mask according to claim 1, wherein the vocal guide is constructed from a material having an acoustic absorption coefficient of below about 0.2 across any one or more of the following frequencies: about 160 Hz, about 200 Hz, about 250 Hz, about 315 Hz, about 400 Hz, about 500 Hz, about 630Hz, about 1,000 Hz, about 1,250 Hz, about 1,600 Hz, about 2,000 Hz, about 2,500 Hz, about 3,150 Hz, about 4,000 Hz, about 5,000 Hz, about 6,300 Hz, and about 8,000 Hz.

20. A face mask kit comprising a frame and a vocal guide according to claim 1, and further comprising a face-contacting seal securable to a proximal end of the frame and a filtration unit securable to a distal end of the frame.

21. A vocal guide for use with a face mask comprising a frame defining a respiratory chamber, for receiving nose and mouth portions of a user, between a proximal end of the frame for interfacing with a face portion of the user and a distal end of the frame configured for allowing gas exchange with the environment,
the vocal guide being defined by a sectional portion of the frame, the guide comprising an arched nose ridge portion, side wall portions extending from the nose ridge portion and a base connecting the side wall portions, and
wherein the guide is configured with a contoured portion located at one or more regions of each of the side wall portions so as to substantially retain acoustic energy at select frequencies of sound waves travelling through the frame for improving speech intelligibility of the mask during use.

22. A vocal guide according to claim 21, wherein the contoured portion is an inwardly-projecting contour.

23. A face mask according to claim 21, wherein the contoured portion is an outwardly-projecting contour.

24. A vocal guide according to claim 21, wherein the contoured portion located at a region of the nose ridge portion.

25. A vocal guide according to claim 21, wherein the vocal guide is constructed from a material having an acoustic absorption coefficient of below about 0.2 across any one or more of the following frequencies: about 160 Hz, about 200 Hz, about 250 Hz, about 315 Hz, about 400 Hz, about 500 Hz, about 630Hz, about 1,000 Hz, about 1,250 Hz, about 1,600 Hz, about 2,000 Hz, about 2,500 Hz, about 3,150 Hz, about 4,000 Hz, about 5,000 Hz, about 6,300 Hz, and about 8,000 Hz.
